(19) United States
(12) Patent Application Publication
(10) Pub. No.: US 2025/0228290 A1
(43) Pub. Date: Jul. 17, 2025

(54) ELECTRONIC CIGARETTE CAN BE QUICKLY DISASSEMBLED AND ASSEMBLED

(71) Applicant: Shenzhen Haohan Yangtian Technology Co., Ltd., Shenzhen (CN)

(72) Inventors: LEI KONG, Shenzhen (CN); JIAJUN CHEN, Shenzhen (CN); DI ZHANG, Shenzhen (CN)

(21) Appl. No.: 18/604,798

(22) Filed: Mar. 14, 2024

(30) Foreign Application Priority Data
Jan. 16, 2024 (CN) 202410056585.2

(51) Int. Cl. A24F 40/40; A24F 40/90; H01M 10/46; H01M 50/202; H01M 50/224; H01M 50/247; H01M 50/271

(52) U.S. Cl. CPC A24F 40/40; A24F 40/90; H01M 10/46; H01M 50/202; H01M 50/224; H01M 50/247; H01M 50/271; H01M 2220/30

(57) ABSTRACT

An electronic cigarette structure that can be quickly disassembled and assembled is provided, which includes a cigarette holder module, a battery cell module, and a host module. The cigarette holder module is provided with the battery cell module and the host module; the battery cell module includes a battery cell upper cover, a stainless-steel shell, a soft pack battery cell, a charging board, a second Type-C female terminal, and a battery cell lower cover. The host module includes a bracket, a magnet, a conductive pin, a first Type-C male terminal, a scheme board, a first Type-C female terminal, a base, and a button. The electronic cigarette achieves rapid disassembly and assembly through a magnetic suction structure and Type-C interface insertion and extraction structure. On the basis of one-time use, it realizes functions of recycling and disassembly, extends the service life of the product, and reduces environmental pollution.

### CROSS-REFERENCE TO RELATED APPLICATIONS

This application claims priority to Chinese Patent Application No. 202410056585.2, filed on Jan. 16, 2024, which is hereby incorporated by reference in its entirety.

### TECHNICAL FIELD

The present disclosure relates to the field of electronic cigarettes technologies, and in particular, to an electronic cigarette structure that can be quickly disassembled and assembled.

### BACKGROUND

The field of electronic cigarettes is increasingly emphasizing ecological and environmental protection, relevant laws and regulations have been introduced around the world. The detachable electronic cigarettes on the market are inconvenient to disassemble, requiring the use of tools for disassembly. After disassembly, the host and battery cells are not convenient to recycle and reuse.

### SUMMARY

In response to the above-mentioned shortcomings in existing technology, the present disclosure provides an electronic cigarette structure that can be quickly disassembled and assembled, aiming to solve the problems of inconvenient disassembly of detachable electronic cigarettes on the market, requiring the use of tools for disassembly, and inconvenient recycling and reuse of the host and battery cells after disassembly.

In order to achieve the above-mentioned disclosure objectives, the technical solution adopted by the present disclosure is as following.

An electronic cigarette structure that can be quickly disassembled and assembled, including a cigarette holder module, a battery cell module, and a host module, the cigarette holder module is provided with the battery cell module and the host module;
the battery module includes a battery cell upper cover, a stainless-steel shell, a soft pack battery cell, a charging board, a second Type-C female terminal, and a battery cell lower cover;
the host module includes a bracket, a magnet, a conductive pin, a first Type-C male terminal, a scheme board, a first Type-C female terminal, a base, and a button.

In an embodiment of the present disclosure, a top of the stainless-steel shell is provided with the batter cell upper cover, the stainless-steel shell is provided with the soft pack battery cell, the stainless-steel shell is provided with the charging board, the battery cell lower cover is provided below the charging board.

In an embodiment of the present disclosure, the button is provided at a bottom of the base, the scheme board is provided in the base, the first Type-C male terminal is provided at a top of the scheme board, a bracket is provided above the scheme board, the conductive pin and the magnet are provided between the bracket and the scheme board.

In an embodiment of the present disclosure, the charging board is provided with the second Type-C female terminal.

In an embodiment of the present disclosure, the first Type-C female terminal is provided on the scheme board.

In an embodiment of the present disclosure, the battery cell module and the host module are connected through the first Type-C male terminal and the second Type-C female terminal.

The beneficial effects of the present disclosure are:
the present disclosure relates to an electronic cigarette structure that can be quickly disassembled and assembled, which achieves modular assembly of rapid disassembly and assembly through a magnetic suction structure and Type-C interface insertion and extraction structure. The modular design is convenient for manual quick disassembly, does not require tools, and can be sorted and recycled on its own. On the basis of one-time use, it further realizes functions of recycling and disassembly, extends the service life of the product, reduces the frequency of product replacement, and reduces environmental pollution.

### BRIEF DESCRIPTION OF DRAWINGS

FIG. 1 is a structural schematic diagram of an electronic cigarette that can be quickly disassembled and assembled of the present disclosure.

FIG. 2 is a structural schematic diagram of a battery cell module of the present disclosure.

FIG. 3 is a structural schematic diagram of a host module of the present disclosure.

Numeral reference
1. Cigarette holder module; 2. Battery cell module; 3. Host module; 4. Bracket; 5. Magnet; 6. Conductive pin; 7. First Type-C male terminal; 8. Scheme board; 9. First Type-C female terminal; 10. Base; 11. Button; 12. Battery cell upper cover; 13. Stainless-steel shell; 14. Soft pack battery cell; 15. Charging board; 16. Second Type-C female terminal; 17. Battery cell lower cover.

### DESCRIPTION OF EMBODIMENTS

The specific embodiments of the present disclosure will be further explained in combination with the drawings. The same components are marked with the same drawings.

It should be noted that words “front”, “back”, “left”, “right”, “up”, and “down” used in the following description refer to the directions in the drawings, while words “inside” and “outside” respectively refer to directions facing or away from a geometric center of a specific component.

In order to make the content of the present disclosure easier to understand, the following will provide a clear and complete description of the technical solution in the embodiments of the present disclosure in combination with the drawings.

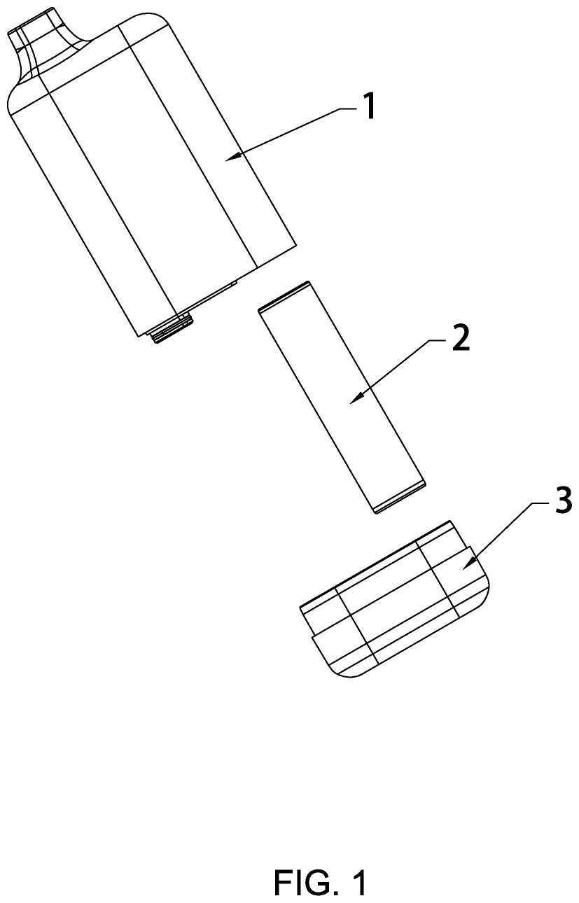

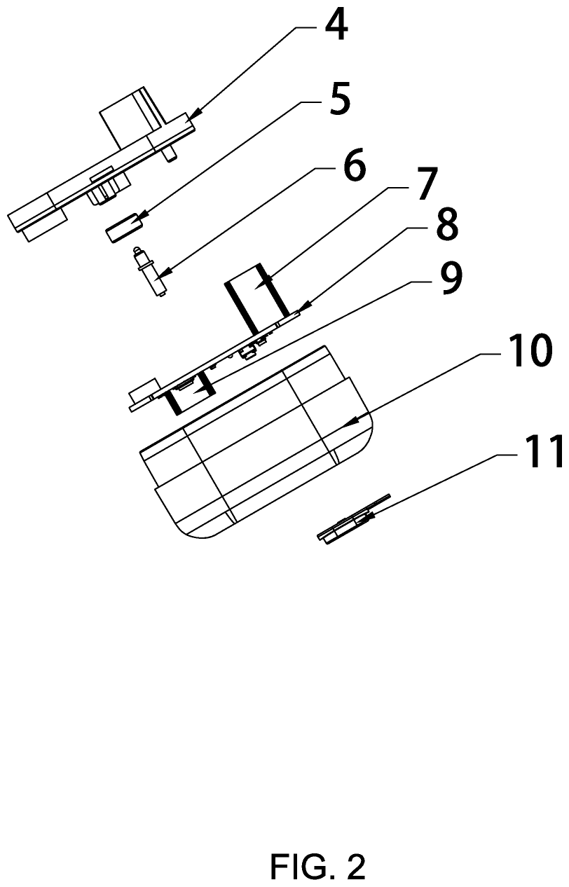

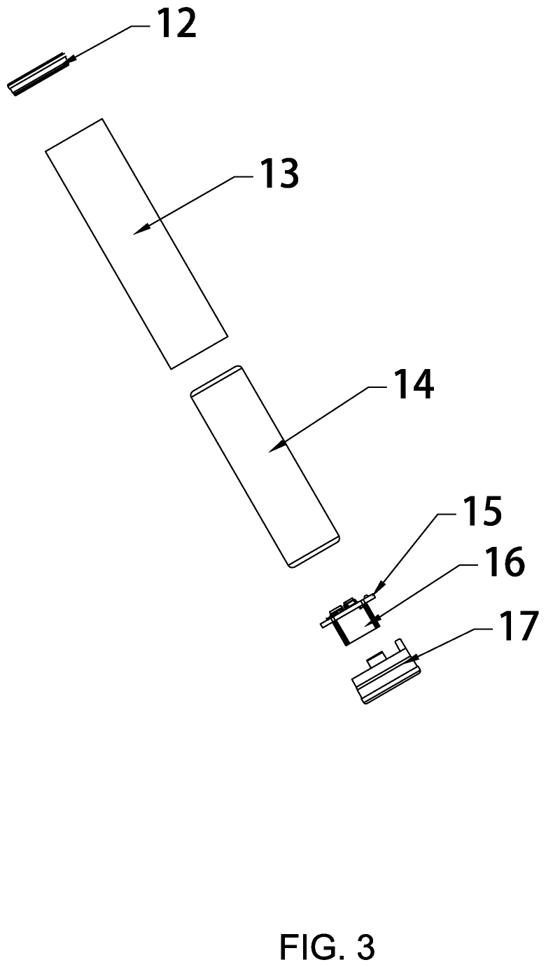

As shown in FIGS. 1 to 3, an electronic cigarette structure that can be quickly disassembled and assembled, which includes a cigarette holder module 1, a battery cell module 2, and a host module 3. The cigarette holder module 1 is provided with the battery cell module 2 and the host module 3.

The battery cell module 2 includes a battery cell upper cover 12, a stainless-steel shell 13, a soft pack battery cell 14, a charging board 15, a second Type-C female terminal 16, and a battery cell lower cover 17.

A top of the stainless-steel shell 13 is provided with the battery cell upper cover 12, the stainless-steel shell 13 is provided with the soft pack battery cell 14 inside. The stainless-steel shell 13 is provided with the charging board 15, the charging board 15 is provided with the second Type-C female terminal 16. The battery cell lower cover 17 is located below the charging board 15.

The host module 3 includes a bracket 4, a magnet 5, a conductive pin 6, a first Type-C male terminal 7, a scheme board 8, a first Type-C female terminal 9, a base 10, and a button 11.

A bottom of the base 10 is provided with the button 11, the scheme board 8 is provided in the base 10. The scheme board 8 is provided with the first Type-C female terminal 9, a top of the scheme board 8 is provided with the first Type-C male terminal 7. The bracket 4 is provided above the scheme board 8, the conductive pin 6 and the magnet 5 are provided between the bracket 4 and the scheme board 8.

The scheme board 8 includes the first Type-C male terminal 7 in combination with the second Type-C female terminal 16 on the battery cell module 2. A Type-C charging cable is inserted into the first Type-C female terminal 9 to charge the battery cell module 2.

The charging board 15 includes the second Type-C female terminal 16, which can be used in combination with the first Type-C male terminal 7 on the scheme board 8 as input charging, or can be used separately with Type-C charging wires as input charging.

The charging board 15 includes the second Type-C female terminal 16, which can be used as an output terminal when assembled into a complete machine.

The battery cell module 2 and host module 3 are connected through the first Type-C male terminal 7 and the second Type-C female terminal 16. Then, the battery cell module 2 and the host module 3 are inserted together into the cigarette holder module 1 and connected together through a magnetic suction structure. The second Type-C female terminal 16 on the battery cell module 2 is used as an output terminal.

When disassembling, the host module 3 and the battery cell module 2 are simply pulled out together from the cigarette holder module 1, and then the battery cell module 2 is pulled out from the host module 3 to achieve module separation and classification for recycling.

After disassembling and recycling the battery cell module 2, it can be charged using Type-C charging wires, or it can be assembled with the host module 3 to charge using Type-C charging wires, rendering recycling convenient and fast.

The above is only a preferred embodiment of the present disclosure patent and is not intended to limit it. Any modifications, equivalent substitutions, and improvements made within the spirit and principles of the present disclosure should be included within the protection scope of the present disclosure.

What is claimed is:

1. An electronic cigarette that can be quickly disassembled and assembled, comprising: a cigarette holder module (1), a battery cell module (2), and a host module (3), wherein the cigarette holder module (1) is provided with the battery cell module (2) and the host module (3);
the battery cell module (2) comprises a battery cell upper cover (12), a stainless-steel shell (13), a soft pack battery cell (14), a charging board (15), a second Type-C female terminal (16), and a battery cell lower cover (17);
the host module (3) comprises a bracket (4), a magnet (5), a conductive pin (6), a first Type-C male terminal (7), a scheme board (8), a first Type-C female terminal (9), a base (10), and a button (11).

2. The electronic cigarette according to claim 1, wherein a top of the stainless-steel shell (13) is provided with the battery cell upper cover (12), the stainless-steel shell (13) is provided with the soft pack battery cell (14), the stainless-steel shell (13) is provided with the charging board (15), the battery cell lower cover (17) is provided below the charging board (15).

3. The electronic cigarette according to claim 1, wherein the button (11) is provided at a bottom of the base (10), the scheme board (8) is provided in the base (10), the first Type-C male terminal (7) is provided at a top of the scheme board (8), a bracket (4) is provided above the scheme board (8), the conductive pin (6) and the magnet (5) are provided between the bracket (4) and the scheme board (8).

4. The electronic cigarette according to claim 1, wherein the charging board (15) is provided with the second Type-C female terminal (16).

5. The electronic cigarette according to claim 1, wherein the first Type-C female terminal (9) is provided on the scheme board (8).

6. The electronic cigarette according to claim 2, wherein the battery cell module (2) and the host module (3) are connected through the first Type-C male terminal (7) and the second Type-C female terminal (16).
